(19) United States
(12) Patent Application Publication
(10) Pub. No.: US 2004/0103930 A1
(43) Pub. Date: Jun. 3, 2004

(54) Dishwasher

(75) Inventor: Yong Jae Lee, Ulsan-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/721,247

(22) Filed: Nov. 26, 2003

(30) Foreign Application Priority Data
Nov. 28, 2002 (KR) P2002-74993

(51) Int. Cl. B08B 3/10

(52) U.S. Cl. 134/93; 134/95.3; 134/98.1; 134/100.1; 134/113; 68/13 A

(57) ABSTRACT

Disclosed is a dishwasher having an improved water softener. The present invention includes a housing, a tub in the housing to hold tableware, an injector assembly for injecting water on the tableware in the tub, and a water softener softening the water supplied to the injector assembly, the water softener including a first container holding an ion-exchange resin for removing heavy metal and metal ions from the water, a second container holding a predetermined amount of salt and salt water to supply the salt water to the first container to recycle the ion-exchange resin that is saturated, a float installed in the second container, and a sensor provided to the second container to sense a concentration of the salt water according to a distance from the float.

This application claims the benefit of Korean Application(s) No. 10-2002-0074993 filed on Nov. 28, 2002 which is/are hereby incorporated by reference.

### BACKGROUND OF THE INVENTION

1. Field of the Invention

The present invention relates to dishwasher, and more particularly, to a water softener of a dishwasher, by which water is softened.

2. Discussion of the Related Art

Generally, a dishwasher is an apparatus for cleaning tableware held therein by injecting water. Soft water is advantageous in enhancing a washing efficiency, a water softener for softening water before injection onto the tableware is provided to the dishwasher.

The water softener includes a filter removing specific contents dissolved in water. And, the filter includes an ion-exchange resin adsorbing heavy metal and impurity ions in the water. Moreover, if the ion-exchange resin is saturated, salt water is used fro recycling the ion-exchange resin. Hence, the water softener includes a container for holding the salt water, and salt is held in the container to prepare the salt water repeatedly as well.

In operating the dishwasher, as the salt water is repeatedly used to recycle the ion-exchange resin to consume salt, the salt has to be periodically recharged. Hence, a sensor for detecting a shortage of salt is provided to the water softener. For instance, in the related art sensor, a float is installed in the salt water container and a switch is attached to a lower outside of the container. As a salt concentration of the salt water is lowered, the float is gradually lowered as well. Once the float comes in the vicinity of the switch, a magnetic force of a magnet provided to the float brings two contacts of the switch into contact with each other to generate an electric signal for alarming the salt shortage.

However, the magnetic force works within a predetermined range, the switch may be turned on even if the float is not sufficiently lowered. Moreover, a shock generated from the operating dishwasher may turn on the switch as well. Hence, the related art sensor is incredible as well as inaccurate.

### SUMMARY OF THE INVENTION

Accordingly, the present invention is directed to a dishwasher that substantially obviates one or more of the problems due to limitations and disadvantages of the related art.

An object of the present invention, which has been devised to solve the foregoing problem, lies in providing a dishwasher, by which a concentration of salt water is accurately sensed.

It is another object of the present invention to provide a dishwasher, by which a shortage of salt is accurately sensed based on a sensed concentration of salt water.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a dishwasher including a housing, a tub in the housing to hold tableware, an injector assembly for injecting water on the tableware in the tub, and a water softener softening the water supplied to the injector assembly, the water softener including a first container holding an ion-exchange resin for removing heavy metal and metal ions from the water, a second container holding a predetermined amount of salt and salt water to supply the salt water to the first container to recycle the ion-exchange resin that is saturated, a float installed in the second container, and a sensor provided to the second container to sense a concentration of the salt water according to a distance from the float.

The float fluctuates in height according to the concentration of the salt water. A guide for guiding floatage of the float is further provided to the second container. And, the float includes a body and a magnet attached to the body.

The sensor senses an amount of the salt in the second container according to the distance from the float. Preferably, the sensor senses a shortage of the salt in the second container according to the distance from the float.

The sensor generates a current if the distance from the float is smaller than a predetermined distance or generates a current to vary according to the distance from the float. Preferably, the dishwasher further includes an information device informing the concentration of the salt water according to a signal generated from the sensor. And, the information device informs a shortage of the salt amount.

Therefore, by the present invention, the shortage of the salt amount and the concentration of the salt water in the water softener can be accurately measured to judge the shortage and the recharging time of the salt accurately.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a dishwasher according to the present invention;

FIG. 2 is a cross-sectional view of a dishwasher according to the present invention; and

FIG. 3A and FIG. 3B are front views of a water softener of a dishwasher according to the present invention.

### DETAILED DESCRIPTION OF THE PREFERRED EMBODIMENT(S)

Reference will now be made in detail to the preferred embodiment(s) of the present invention, examples of which are illustrated in the accompanying drawings. Throughout the drawings, like elements are indicated using the same or similar reference designations where possible.

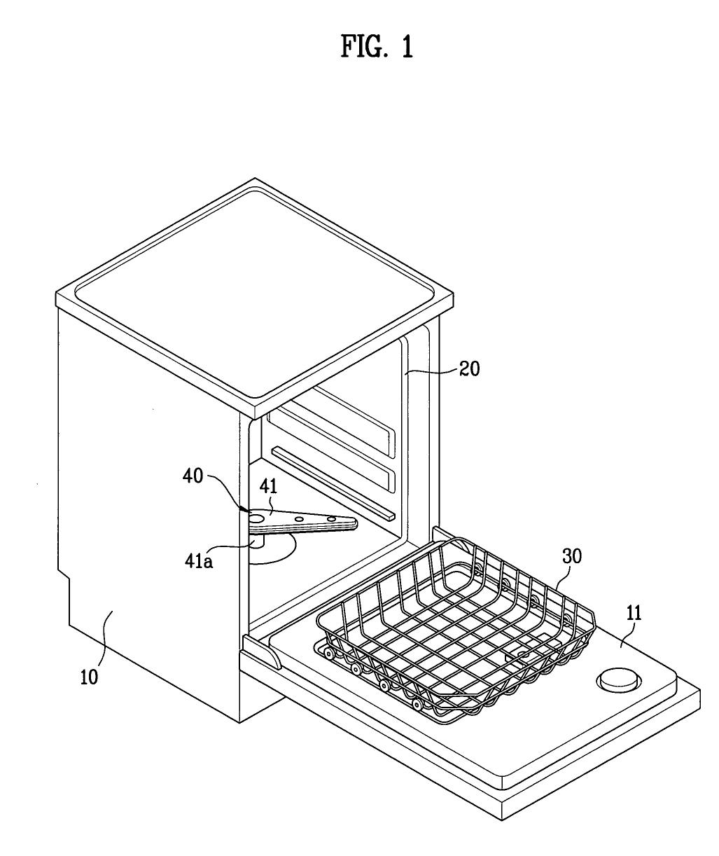

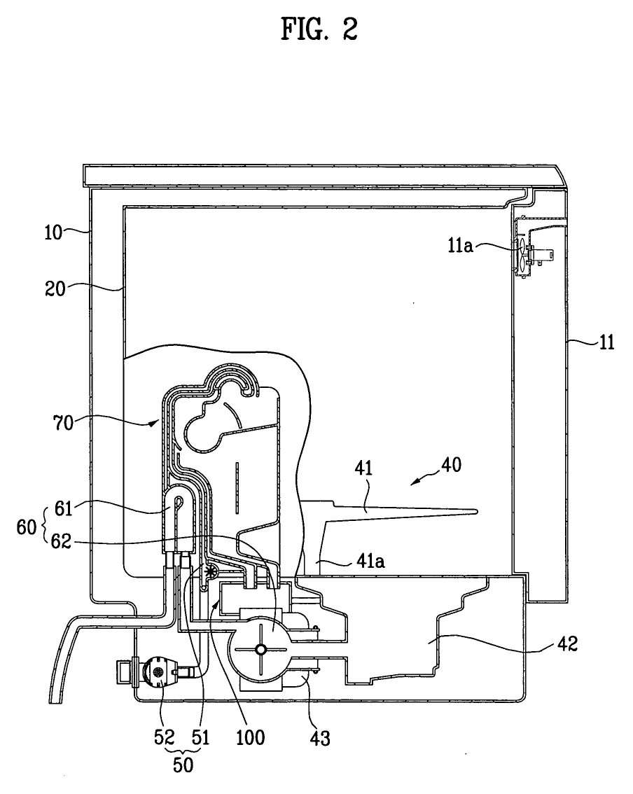

FIG. 1 is a perspective view of a dishwasher according to the present invention and FIG. 2 is a cross-sectional view of a dishwasher according to the present invention.

Referring to FIG. 1 and FIG. 2, a dishwasher according to the present invention basically includes a housing 10 and a tub 20, a rack 30, and an injector assembly 40 installed in the housing 10.

The housing 10 is designed to install to protect various equipments inside. A door 11 is installed at a front side of the housing 10 to open/close an entrance of the tub 20, and a user puts or pulls tableware in or out of the tub 20 via the entrance. A fan 11a is installed at the door 11 to blow air for drying the washed tableware.

The tub 20 provides a space for holding the tableware to be washed. The rack 30 is installed in the tub 20 and a plurality of tableware are arranged on the rack 30 to leave a distance appropriate for washing. The rack 30 is constructed to enable to discharge water smoothly, and is detachably installed on a sidewall of the tub 20 to be conveniently put in or drawn out of the tub 20.

The injector assembly 40 is constructed to inject water onto the tableware. Specifically, the injector assembly 40 includes a nozzle 41 installed in the tub 20, a sump 42 communicating with the nozzle 41, and a pump 43. The nozzle 41 is connected to the sump 42 by a connecting pipe 41a. Preferably, the nozzle 41 is rotatably installed in the tub 20 to evenly inject the water on the tableware. The sump 42 is installed under the tub 20, and preliminarily stores the water to supply to the nozzle 41 uniformly. And, the pump 43 is installed in the vicinity of the sup 42, and pumps up the water in the sump 42 to the nozzle 41 for injection of the water.

Moreover, a water supply assembly 50 for supplying water to the sump 42 and a drain assembly 60 for discharging the used water are installed in the dishwasher. The water supply assembly 50 includes an inlet passage 51 and a valve 52 installed at the inlet passage 51. The inlet passage 51 is connected to the sump 42 and extends to an eternal water supply source through the housing 10. The valve 52 selectively opens or cuts off the inlet passage 51. Once the valve is turned on, the water is supplied to the sump 42 from the water supply source via the inlet passage 51. Moreover, the drain assembly 60 includes a drain passage 61 and a pump 62 communicating with the drain passage 61. Specifically, the drain passage 61 is connected to the sump 42, and extends outside the dishwasher via the pump 62. The water used in washing is stored in the sump 42 gain and is repeatedly injected onto the tableware by the injector assembly 40. After completion of washing, once the pump 62 is driven, the used water is discharged outside the dishwasher via the drain passage 61. Portions of the inlet and drain passages 51 and 61 are built in one body as one passage module 70. The passage module 70 preferably simplifies a construction of the tableware.

As explained in the foregoing description, softer water is preferably used as water for washing tableware efficiently. Hence, a water softener 100 is installed in the inlet passage 51 to soften water.

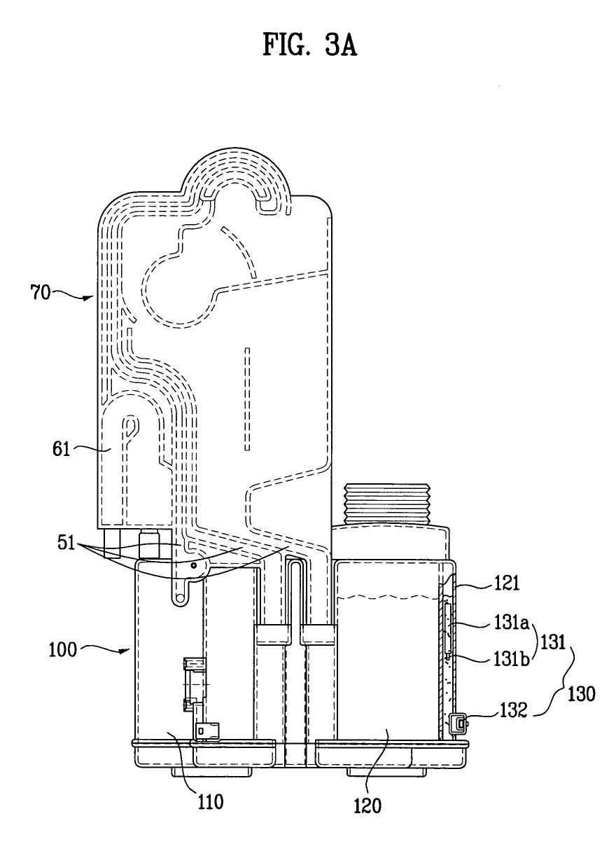

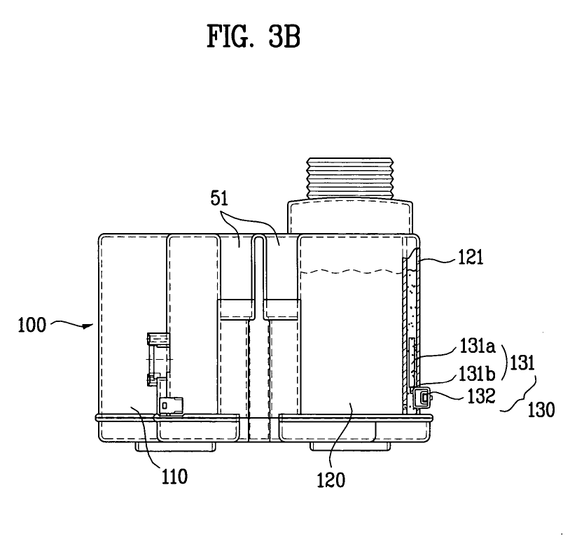

FIG. 3A and FIG. 3B are front views of a water softener of a dishwasher according to the present invention.

Referring to FIG. 3A and FIG. 3B, the water softener 100 basically includes a first container 110 softening water and a second container 120 supplementing a function of the first container 110.

The first container 110 holds a filter (not shown in the drawing), and the filter eliminates components hardening the water. The filter substantially includes an ion-exchange resin adsorbing and eliminating heavy metal and metal ions by ion-exchange. The first container 110 is connected to the inlet passage 51 and is also connected to the sump 42 by the inlet passage 51. Hence, once the valve 52 is turned on, the water is softened in the first container 110 and is then supplied to the sump 42.

After use for a predetermined time, an exchange capacity of the filter becomes exhausted so that the filter is unable to soften the water any more. Namely, the ion-exchange resin is saturated to be unable to exchange ions with the inflowing water. In this case, a certain liquid for recycling the ion-exchange resin is used, and is held in the second container 120. Generally, salt water is used as the recycling liquid. In order to provide the salt water repeatedly, a prescribed amount of salt is stored in the second container 120 as well. Like the first container 110, the second container 120 is connected to the inlet passage 51m and a valve (not show in the drawing) is installed to selectively open/close the inlet passage 51. In order to supply the recycling liquid, e.g., salt water, the second container 120 is connected to the first container 110 via a predetermined passage. A valve for opening/closing the predetermined passage can be installed at the predetermined passage between the first and second containers 110 and 120. Hence, in case that the ion-exchange resin is saturated, the valve is turned on to supply a predetermined amount of water to the second container 120 via the inlet passage 51. Salt water is then prepared in the second container 120 by dissolution of salt. And, the prepared salt water is supplied to the first container 110 from the second container 120, thereby recycling the ion-exchange resin.

Meanwhile, the ion-exchange resin is repeatedly saturated in using the dishwasher. So, the salt water is repeatedly prepared for recycling the ion-exchange resin as well. Since there exists a predetermined amount of salt in the second container 120, a concentration of the salt water becomes reduced gradually. In recycling the ion-exchange resin, an appropriate concentration of the salt water is about 10% in general. If the concentration of the salt water is smaller than 10%, the ion-exchange resin fails to be properly recycled. Hence, the concentration of the salt water should be kept uniform to keep softening the water, whereby information for concentration variation is needed to keep the required concentration of the salt water. For this, the water softener 100 further includes a sensor assembly 130 sensing the concentration of the salt water in the second container 120. The sensor assembly 130 includes a float 131 inside the second container 120 and a sensor 132 outside the second container 120.

First of all, the float 131 is made to fluctuate in height according to the concentration of the salt water. Namely, if the concentration of the salt water is high, buoyancy relatively increases so that the float 131 lies relatively high. When the concentration of the salt water gradually decreases, the float 132 becomes lowered due to the decreasing buoyancy. Specifically, the float 131 includes a body 131a of a predetermined size and a magnet 131b attached to the body 131a. The magnet 131b keeps irradiating magnetic flux to work as an indicator indicating a location of the float 131. Moreover, the second container 120 further includes a guide 121 for guiding a floating of the float 131. The guide 131 extends in parallel with a sidewall of the second container 120 to leave a predetermined distance. The guide 131 and the sidewall substantially provide a channel communicating with the second container 120. The channel is filled with the salt water so that the float 131 stably moves upward and downward.

The sensor 132 is installed at a lower outside of the second container 120, and basically senses the location of the float 131. Namely, the sensor 132 firstly senses a distance between the float 131 and itself by the magnet 131b. As mentioned in the foregoing description, the float 131 fluctuates according to the concentration of the salt water, whereby the distance between the float 131 and the sensor 132. Hence, the distance between the float 131 and the sensor 132 indicates the concentration of the salt water in direct, whereby the concentration of the salt water is sensed based on such a distance.

Meanwhile, since the reduction of the concentration of the salt water depends on salt consumption, the sensor 132 enables to indirectly sense the slat amount in the second container 120 as well. Likewise, the sensor 132 enables to sense a shortage of the salt based on the concentration. Namely, if the concentration is lower than a reference, it is determined that the second container 120 is short of salt.

Specifically, the sensor 132 senses the distance from the float 131 and generates a signal corresponding to the sensed distance. When the concentration of the salt water is lowered in the second container 120, the magnet 131b and body 131a of the float 131, as shown in FIG. 3B, sinks downward. As the magnet 131b gets closer to the sensor 132, the sensor 132 generates a specific signal. In generating the specific signal, the sensor 132 may generate an electric current if the distance from the float 131 is smaller than a predetermined value for example. Namely, a considerable reduction of the concentration and the shortage of the salt are instantly judged. Moreover, the sensor 132 enables to vary a size of the current generated according to the distance from the float 131. In this case, the concentration of the salt water and the salt amount are continuously judged. If the current is smaller than a predetermined value, it is determined to supply the salt. There are various ways of generating a signal for sensing the concentration and the amount and shortage of the salt accurately from the sensor 132.

Such a signal generated from the sensor 132 is transferred to an information device of the dishwasher and is then displayed as information understood by a user. Namely, when the sensor 132 generates the signal if the distance from the float 131 is shorter than the predetermined distance, the information device may be an alarming device for displaying the salt shortage using characters or alarm light. Moreover, in case that the sensor 132 keeps generating different signals according to the distance from the float 131, the information device may be a display device continuously displaying variations of the concentration of the salt water and the salt amount using characters or symbols. Like the alarming device, such a display device enables to inform the user of the shortage of the salt as well. Consequently, the user enables to keep supplying the salt to maintain the concentration of the salt water over a reference in the second container 120 using the information device.

Accordingly, the dishwasher according to the present invention has the following advantages or effects.

First of all, the water softener is equipped with the sensor assembly including the float and the sensor for sensing the concentration according to the distance from the float. Hence, the sensor assembly is simply constructed and enables to sense the concentration of the salt water and the slat amount accurately and continuously. Moreover, the recharging time and amount of the salt can be accurately determined by the accurate sensing. Therefore, the present invention enables to enhance the reliance and stability thereof.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A dishwasher comprising:
a housing:
a tub in the housing to hold tableware;
an injector assembly for injecting water on the tableware in the tub; and
a water softener softening the water supplied to the injector assembly, the water softener comprising:
a first container holding an ion-exchange resin for removing heavy metal and metal ions from the water;
a second container holding a predetermined amount of salt and salt water to supply the salt water to the first container to recycle the ion-exchange resin that is saturated;
a float installed in the second container; and
a sensor provided to the second container to sense a concentration of the salt water according to a distance from the float.

2. The dishwasher as claimed in claim 1, wherein the float fluctuates in height according to the concentration of the salt water.

3. The dishwasher as claimed in claim 1, wherein a guide for guiding floatage of the float is further provided to the second container.

4. The dishwasher as claimed in claim 1, wherein the float comprises a body and a magnet attached to the body.

5. The dishwasher as claimed in claim 1, wherein the sensor senses an amount of the salt in the second container according to the distance from the float.

6. The dishwasher as claimed in claim 1, wherein the sensor senses a shortage of the salt in the second container according to the distance from the float.

7. The dishwasher as claimed in claim 1, wherein the sensor generates a current if the distance from the float is smaller than a predetermined distance.

8. The dishwasher as claimed in claim 1, wherein the sensor generates a current to vary according to the distance from the float.

9. The dishwasher as claimed in claim 1, further comprising an information device informing the concentration of the salt water according to a signal generated from the sensor.

10. The dishwasher as claimed in claim 1, further comprising an information device informing a salt amount in the second container.

11. The dishwasher as claimed in claim 10, wherein the information device informs a shortage of the salt amount.

12. A water softener of a dishwasher, the water softener softening water supplied to an injector assembly of the dishwasher, the water softener comprising:
a first container holding an ion-exchange resin for removing heavy metal and metal ions from the water;
a second container holding a predetermined amount of salt and salt water to supply the salt water to the first container to recycle the ion-exchange resin that is saturated;
a float installed in the second container; and
a sensor provided to the second container to sense a concentration of the salt water according to a distance from the float.

13. The water softener as claimed in claim 12, wherein the float fluctuates in height according to the concentration of the salt water.

14. The water softener as claimed in claim 12, wherein a guide for guiding floatage of the float is further provided to the second container.

15. The water softener as claimed in claim 12, wherein the float comprises a body and a magnet attached to the body.

16. The water softener as claimed in claim 12, wherein the sensor senses an amount of the salt in the second container according to the distance from the float.

17. The water softener as claimed in claim 12, wherein the sensor senses a shortage of the salt in the second container according to the distance from the float.

18. The water softener as claimed in claim 12, wherein the sensor generates a current if the distance from the float is smaller than a predetermined distance.

19. The water softener as claimed in claim 12, wherein the sensor generates a current to vary according to the distance from the float.

20. The water softener as claimed in claim 12, further comprising an information device informing the concentration of the salt water according to a signal generated from the sensor.

21. The water softener as claimed in claim 12, further comprising an information device informing a salt amount in the second container.

22. The dishwasher as claimed in claim 21, wherein the information device informs a shortage of the salt amount.
